(19) United States
(12) Patent Application Publication
(10) Pub. No.: US 2024/0383107 A1
(43) Pub. Date: Nov. 21, 2024

(54) CAM-ACTUATABLE CLAMP AND RELATED COMPONENTS

(71) Applicant: Dadco, Inc., Plymouth, MI (US)

(72) Inventor: Jonathan P. Cotter, Dearborn, MI (US)

(21) Appl. No.: 18/661,128

(22) Filed: May 10, 2024

Related U.S. Application Data
(60) Provisional application No. 63/467,489, filed on May 18, 2023.

(51) Int. Cl. B25B 5/08; B25B 5/02; B25B 5/14

(52) U.S. Cl. CPC B25B 5/08; B25B 5/02; B25B 5/147

(57) ABSTRACT

The clamp assembly includes a mount ring with a first portion including a first passage extending along a first longitudinal axis, a second portion including extending along a second longitudinal axis spaced transversely apart from the first longitudinal passage, and third portion including a third passage extending along a transverse axis between the first and second longitudinal axes, and a clamp movably carried in the third passage of the third portion of the mount ring, and a cam engageable with the clamp to move the clamp toward the first portion of the mount ring. Also disclosed are related clamps and mounting rings.

This application claims the benefit of U.S. Provisional Application No. 63/467,489 filed May 18, 2023 which is hereby incorporated by reference herein in its entirety.

### TECHNICAL FIELD

This disclosure relates generally to fastening devices, more particularly, to a clamp actuatable by a cam.

### BACKGROUND

Fasteners, such as nuts and bolts, are ubiquitous in industry. Some fasteners are adapted for use with mounts for securing round body cylinders in a prepared pocket. For instance, stamping and molding tools commonly include cylindrical products (e.g., gas springs) for shifting components of the stamping or molding tools relative to the tools. In at least some instances, the cylindrical products are arranged in and secured to the stamping or molding tool so as to be able to withstand vibrations, impulse shocks, or other undesirable motion associated with manufacturing. Prior applications have used custom fitting techniques that require time consuming, and excessively precise machining, which increases the overall cost and complexity.

### BRIEF SUMMARY

An illustrative embodiment of a clamp assembly includes a mount ring, wherein the mount ring includes an ovate outer perimeter, a top surface, a bottom surface, and a first portion including a first passage established by a first radially inwardly facing surface at a first radius from a first longitudinal axis extending through the first passage, a second portion including a second passage established by a second radially inwardly facing surface at a second radius from a second longitudinal axis extending through the second passage and spaced transversely away from the first longitudinal axis of the first portion, and a mount ring countersink in the top surface and coaxial with the second passage, and a third portion including a third passage established by laterally inwardly facing walls and extending along a transverse axis between the first longitudinal axis and the second longitudinal axis. The clamp assembly also includes a clamp movably carried in the third passage of the third portion of the mount ring, movable along the transverse axis between an unclamped position relatively toward the second portion and a clamped position relatively toward the first portion, and including a radially inwardly facing clamp surface corresponding to the first radially inwardly facing surface and a cam countersink corresponding to the mount ring countersink, and a cam engageable with the clamp to move the clamp along the third passage toward the first portion of the mount ring.

An illustrative embodiment of clamp assembly includes a mount ring, wherein the mount ring includes an outer perimeter, a first passage extending along a first longitudinal axis, a second passage extending along a second longitudinal axis spaced transversely apart from the first passage, and a third passage extending along a transverse axis between the first and second longitudinal axes. The clamp assembly also includes a clamp configured to be movable with respect to the mount ring along the third passage of the mount ring, and a cam configured to engage with and actuate the clamp along the third passage.

An illustrative embodiment of clamp assembly includes a mount ring, wherein the mount ring includes an ovate outer perimeter, a top surface, a bottom surface, a first portion including a first passage established by a first radially inwardly facing surface at a first radius from a first longitudinal axis extending through the first passage, and having one or more first portion reliefs in the first radially inwardly facing surface and spaced circumferentially around the first radially inwardly facing surface, a second portion including a second passage established by a second radially inwardly facing surface at a second radius from a second longitudinal axis extending through the second passage and spaced transversely away from the first longitudinal axis of the first portion, and having a mount ring countersink in the top surface and coaxial with the second passage, and also having one or more second portion reliefs spaced circumferentially on either side of the mount ring countersink, and a third portion including a third passage established by laterally inwardly facing walls and extending along a transverse axis between the first longitudinal axis and the second longitudinal axis and including a clamp track established by laterally inwardly facing walls, and including protrusions extending laterally inwardly from the laterally inwardly facing walls. The clamp assembly also includes a clamp carried by the clamp track of the third portion of the mount ring, movable along the transverse axis between an unclamped position relatively toward the second portion and a clamped position relatively toward the first portion, and including a radially inwardly facing clamp surface corresponding to the first radially inwardly facing surface and a cam countersink corresponding to the mount ring countersink, a cam to actuate the clamp, and including a conical washer including a central aperture, a conical profile including a diameter that is greater than a distance between the mount ring countersink and the cam countersink when the clamp is in the unclamped position, and an upper surface, and a socket head cap fastener including a head to operatively engage the upper surface of the conical washer, and a shank extending away from the head and through the central aperture of the conical washer.

An illustrative embodiment of a mount ring includes an ovate outer perimeter, a top surface, a bottom surface, a circular portion including a first passage established by a first radially inwardly facing surface at a first radius from a first longitudinal axis extending through the first passage, an arcuate portion including a second passage established by a second radially inwardly facing surface at a second radius from a second longitudinal axis extending through the second passage and also including a mount ring countersink in the top surface and coaxial with the second passage, and a straight portion including a third passage established by laterally inwardly facing walls extending along a transverse axis between the first longitudinal axis and the second longitudinal axis.

An illustrative embodiment of a clamp assembly includes a mount ring, which includes an outer perimeter, a first passage extending along a first longitudinal axis, a second passage extending along a second longitudinal axis spaced transversely apart from the first longitudinal passage, and a third passage extending along a transverse axis between the first and second longitudinal axes. The clamp assembly also includes a clamp movable with respect to the mount ring along a cam track of the third passage of the mount ring, and a protrusion intersecting the third passage along the cam track to retain the clamp in the third passage of the mount ring.

### BRIEF DESCRIPTION OF THE DRAWINGS

FIG. 1 is a perspective view according to an illustrative embodiment of a clamp assembly as applied to a metal forming die including a gas spring;

FIG. 2 is a side view of the metal forming die having the clamp assembly of FIG. 1;

FIG. 3 is an exploded perspective view of the clamp assembly of FIGS. 1 and 2, including a mount ring, a clamp, and a cam;

FIG. 4 is a top view of the mount ring of FIG. 3;

FIG. 5 is a bottom view of the mount ring of FIG. 3;

FIG. 6A is an enlarged cross-sectional view of the mount ring of FIG. 5;

FIG. 6B is a cross-sectional view of another embodiment of a mount ring;

FIG. 6C is a cross-sectional view of another embodiment of a mount ring;

FIG. 6D is a cross-sectional view of another embodiment of a mount ring;

FIG. 6E is a cross-sectional view of another embodiment of a mount ring;

FIG. 7 is a top view of the clamp of FIG. 3;

FIG. 8 is a bottom view of the clamp of FIG. 3;

FIG. 9 is a front view of the clamp of FIG. 3;

FIG. 10 is a side view of the cam of FIG. 3;

FIG. 11 is a side view of another embodiment of a cam;

FIG. 12 is a perspective view of the clamp assembly of FIG. 3 in a clamped position;

FIG. 13 is a top view of the clamp assembly of FIG. 3 in an unclamped position;

FIG. 14 is a top view of the clamp assembly of FIG. 12;

FIG. 15 is a cross-sectional view of the clamp assembly of FIG. 12;

FIG. 16 is a top view according to another illustrative embodiment of a clamp assembly;

FIG. 17 is a cross-sectional view of the clamp assembly of FIG. 16 along line 17-17; and

FIG. 18 is a cross-sectional view of the clamp assembly of FIG. 16 along line 18-18.

FIG. 19 is a top view according to one embodiment of a clamp retained in the clamp assembly in an unclamped position.

FIG. 20 is an enlarged fragmentary view of a portion of the clamp assembly of FIG. 19 taken from Circle 20.

FIG. 21 is an enlarged fragmentary perspective view of another portion of the clamp assembly of FIG. 19 taken from Circle 21.

FIG. 22 is an enlarged, fragmentary cross-sectional view of a portion of the clamp assembly of FIG. 19 taken along line 22-22.

FIG. 23 is a top view according to another embodiment of a clamp retained in a clamp assembly in an unclamped position.

FIG. 24 is a perspective view of the mount ring of FIG. 23.

FIG. 25 is an enlarged fragmentary view of a portion of the clamp assembly depicted in FIG. 23 taken from Circle 23.

FIG. 26 is a top view of the clamp assembly at a maximum extended position.

FIG. 27 is a top view of the clamp assembly showing the clamp being assembled to the mount ring.

### DETAILED DESCRIPTION

In general, a clamp assembly will be described using one or more examples of illustrative embodiments of a gas spring mount for a metal forming die. The example embodiments will be described with reference to use in the metal forming industry. However, it will be appreciated as the description proceeds that the claimed subject matter is useful in many different applications and may be implemented in many other embodiments.

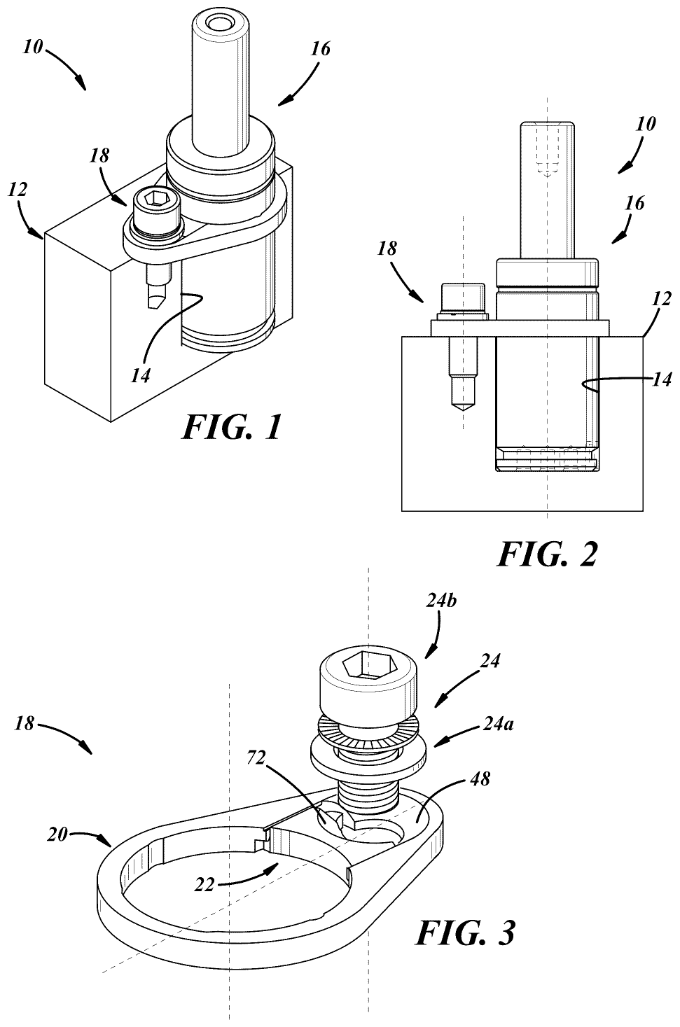

Referring specifically to the drawings, FIGS. 1 and 2 show an illustrative embodiment of a metal forming die assembly 10 including a portion of a die member 12 having a pocket 14, a gas spring 16 disposed in the pocket, and a clamp assembly 18 retaining the gas spring to the die member. As will be described in more detail below, the clamp assembly includes a novel arrangement of features that may provide improved functionality compared to prior clamps.

With reference to FIG. 3, the clamp assembly includes a mount ring 20 arranged about a first longitudinal axis and a second longitudinal axis, a clamp 22 configured to be movable with respect to the mount ring, and a cam 24 configured to engage with and actuate the clamp. As will be described in greater detail below, the clamp assembly may be configured to cooperate with both of the clamp and the mount ring to move the clamp relative to the mount ring to provide a substantially uniform force on a cylinder positioned within the clamp assembly.

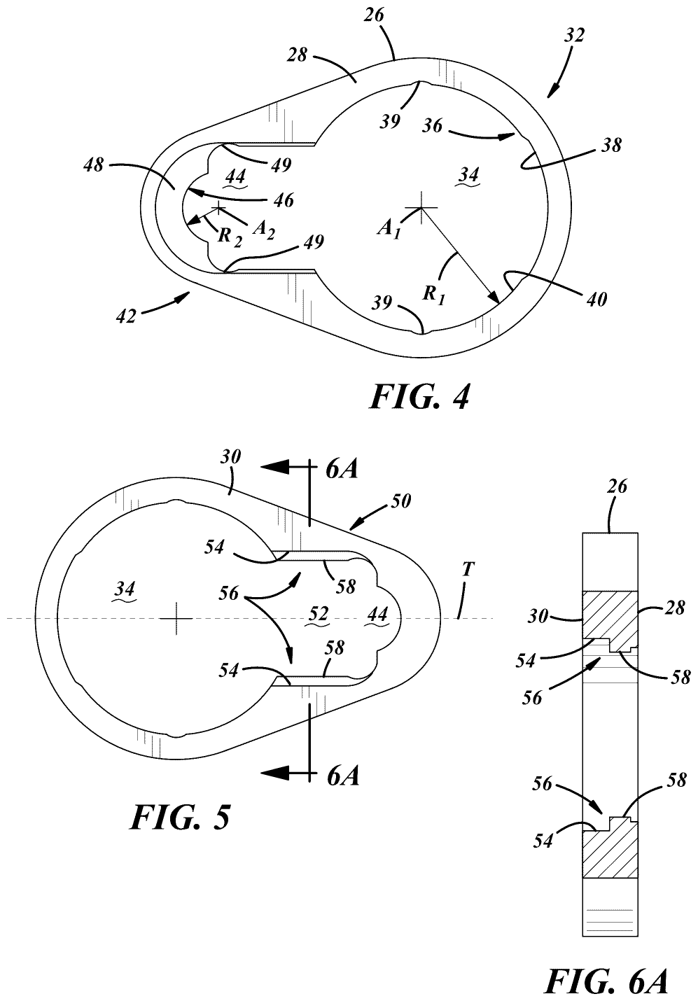

With reference to FIGS. 4, 5, and 6, the mount ring includes an outer perimeter 26, a top surface 28, and a bottom surface 30 (FIG. 5). In the present illustrative embodiment, the outer perimeter has a generally ovate shape and is circumferentially continuous, e.g., having no circumferential interruptions. An ovate outer perimeter may be desirable to reduce cost (i.e., requires less material), however, the outer perimeter can be a non-ovate shape too. The mount ring comprises a thickness extending between the top surface and the bottom surface.

With reference to FIG. 4, the mount ring or clamp housing includes a first or circular portion 32 including a first passage 34 that may be established by a first radially inwardly facing surface 36 at a first radius R1 from the first longitudinal axis extending through the first passage. As shown in FIGS. 1 and 2, the first portion may be arranged for a cylinder such as a gas spring. The first radially inwardly facing surface may include at least one first portion relief 38 and at least one clamping section spaced circumferentially from the first portion relief. The at least one first relief portion may vary in size, such that one of the reliefs 39 may define a greater portion of the circumference of the first radially inwardly facing surface than another relief. In any case, relief from a simple circular shape may be desirable to help compensate for any manufacturing variations and also may help concentrate the load on, for example, 40-60% of the circumference of the first radially inwardly facing surface. Also, the at least one first portion relief may be desirable so that the first portion is elastically deformable. As such, the first portion can flex or temporarily deform at the at least one first portion relief so that the at least one clamping section can exert a substantially uniform and inward force on the cylinder during assembly. Too much relief, however, may result in undesired yielding and/or deflection. On the other hand, if the mount ring does not include enough relief, then manufacturing imperfections may prevent or reduce clamping effectiveness. The inward force provided from the at least one clamping section may be substantially perpendicular to the first longitudinal axis. It may be desirable to clamp on three points of a cylinder to avoid excessive concentrated force and/or avoid product damage. Assemblies that rely on two point or four point clamping may provide unstable clamping and/or may result in unwanted loosening.

With continued reference to FIG. 4, the mount ring further includes a second or arcuate portion 42 including a second passage 44 that may be established by a second radially inwardly facing surface 46 at a second radius R2 from the second longitudinal axis extending through the second passage and spaced transversely away from the first longitudinal axis of the first portion. The second portion may further include a mount ring countersink 48 in the top surface and coaxial with the second passage. One or more second portion reliefs 49 may be spaced circumferentially on either side of the second radially inwardly facing surface and may be desirable for facilitating uninterrupted movement of the clamp with respect to the mount ring.

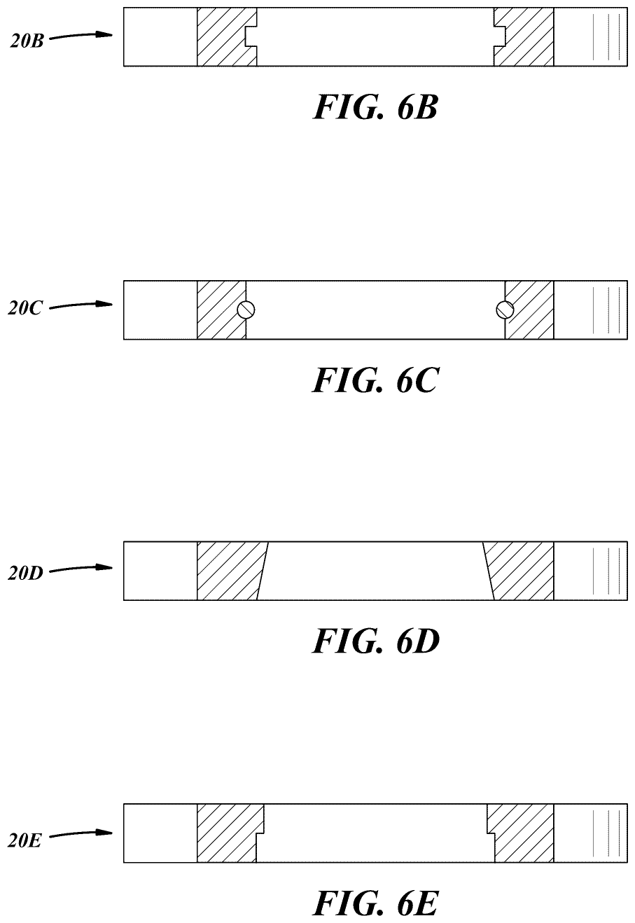

As shown in FIG. 5, a third or straight portion 50 including a third passage 52 may be established by laterally inwardly facing walls 54 extending along a transverse axis between the first longitudinal axis and the second longitudinal axis. With reference to FIG. 6A, the third passage may further include a clamp track 56 established by protrusions 58 that extend inwardly from the laterally inward facing walls and are parallel to the transverse axis T. As shown in FIG. 6A, the protrusions may include an inset or channel that corresponds with at least a portion of the clamp (discussed in more detail below).

FIGS. 6B-6E show additional embodiments of mount rings having other possible arrangements of clamp tracks for supporting and/or guiding a clamp along the transverse axis during operation and/or during assembly. For instance, in FIG. 6B, laterally inwardly facing walls of mount ring 20B include straight gibs that form grooves for receiving at least a portion of the clamp. In FIG. 6C, laterally inwardly facing walls of mount ring 20C include round grooves that are configured to receive a floating pin which is arranged between the mount ring and at least a portion of the clamp. In FIG. 6D, laterally inwardly facing walls of mount ring 20D are inwardly angled walls that correspond with a least a portion of the clamp (e.g., a dovetail shaped clamp). In FIG. 6E, laterally inwardly facing walls of mount ring 20E include a step extending inwardly form the laterally inward facing walls for axially supporting at least a portion of the clamp.

The mount rings 20-20E may be of any suitable construction and composition. For instance, the mount rings 20-20E may be manufactured using a laser, water jet, profile cut, blanked, molded, cast, or with any other suitable process. In at least one embodiment, the mount rings are profile blanked and then machined using a computer numerical control (CNC) machine. The mount rings may be manufactured from one or more materials, such as steel, aluminum, stainless steel, nickel-based alloys, nylon, or another suitable material. Note, however, the material of the mount rings are generally selected to substantially match the strength of the material of the item being clamped (e.g., cylinder body of a gas spring).

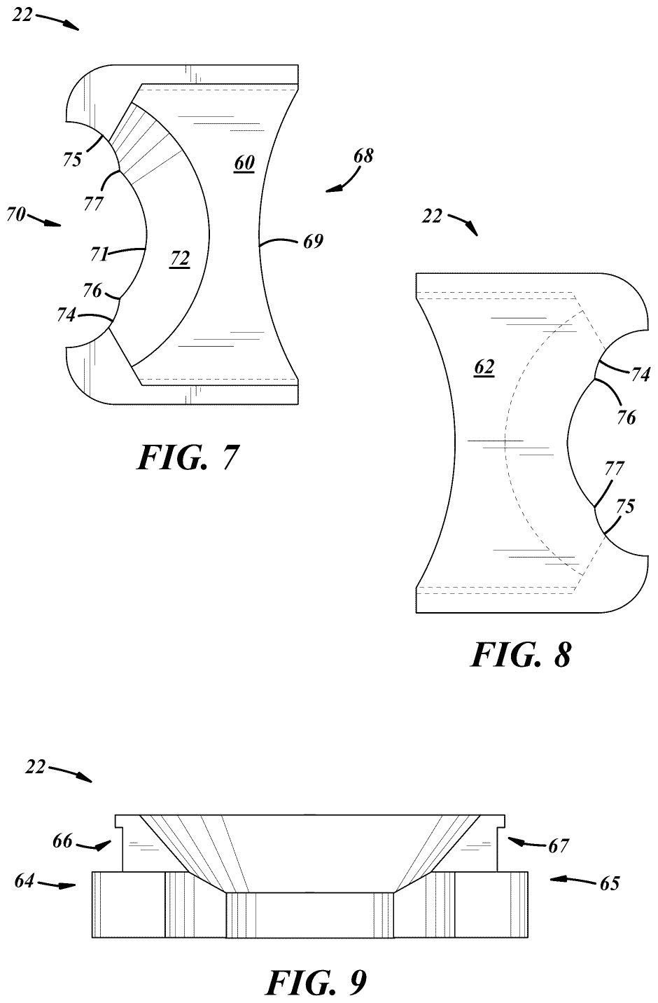

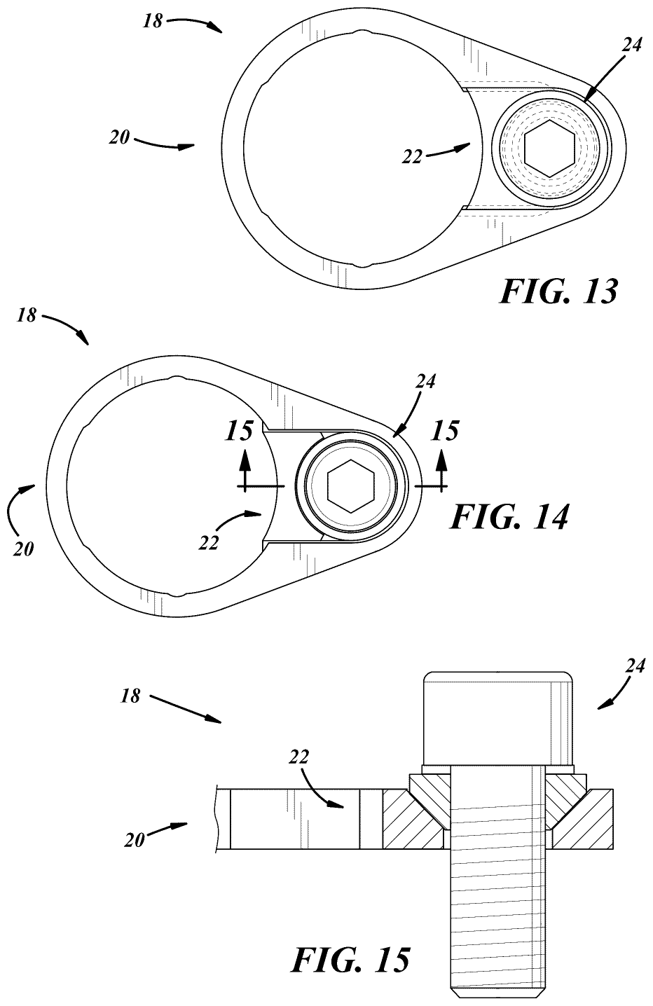

With reference again to FIG. 3, the clamp (i.e., clamp shoe or cam follower) is illustrated so as to be carried within the third portion of the mount ring and is movable along the transverse axis between an unclamped position (FIG. 13) relatively toward the second portion and a clamped position (see FIGS. 12 and 14) relatively toward the first portion. The clamp comprises an upper surface 60 (FIGS. 7 and 9), a lower surface 62 (FIGS. 8 and 9), and a thickness between the upper and lower surfaces. As best shown in FIG. 9, the clamp includes a first laterally outer side 64 extending between the upper and lower surfaces and having a first track element 66. The clamp also includes a second laterally outer side 65 extending between the upper and lower surfaces and having a second track element 67. The first and second track elements of the first and second laterally outer sides may be further defined by grooves or slots which correspond to the protrusions of the third portion of the mount ring.

As shown in FIGS. 6B-6E, the first and second track elements of the clamp may be configured to correspond with different arrangements of the mount ring so that clamp can move with respect to the mount ring and transfer fastening load on a cylinder. For instance, in FIG. 6B, the first and second track elements include teeth that correspond to the grooves on the mount ring. In FIG. 6C, the track elements are round grooves which are configured to receive and travel along the floating pin. In FIG. 6D, the first and second track elements are angled walls that collectively form a dovetail shape and correspond with the angled walls of the mount ring. In FIG. 6E, the first and second track elements are steps that extend outwardly from the clamp and correspond with the steps on the mount ring. Note, these abovementioned illustrative embodiments are just a few possible arrangements of the first and second track elements and other arrangements for guiding the clamp and transferring fastening load during assembly are possible.

With reference to FIG. 7, the clamp further comprises a radially inner end 68, which, with reference to FIG. 3, is configured to be disposed at a first radius from the first longitudinal axis and a radially outer end 70 at a second radius from the second longitudinal axis. The radially inner end may be further defined by a radially inwardly facing surface 69 which corresponds with the first radially inwardly facing surface of the first portion. The radially outward end includes a radially outwardly facing surface 71 which corresponds to the second radially inwardly facing surface 72 of the second portion. The clamp may further comprise a clamp countersink in the upper surface that extends between the upper surface and the radially outer end.

As best shown in FIG. 3, the clamp countersink corresponds with the mount ring countersink on the first portion of the mount ring. In FIGS. 7 and 8, the radially outward end may further include one or more clamp reliefs 74, 75 (e.g., scallops) spaced circumferentially from the radially outwardly facing surface and extending circumferentially between the radially outwardly facing surface and a portion of either the first or second laterally outer sides of the clamp. As best shown in FIGS. 3 and 7, the at least one clamp relief and one of the laterally outer sides of the clamp may form a point or apex 76, 77 configured so as to correspond with the at least one second portion relief of the mount ring. In the present illustrative embodiment, there is an apex on the first lateral side and another apex on the second lateral side, such that when the apexes of the clamp are positioned within the at least one second portion relief of the mount ring, the clamp countersink and the mount ring countersink are at a minimum distance from each other and form a cam seat for the cam.

The clamp may be of any suitable construction and composition. For instance, the clamp may be manufactured using a laser, water jet, profile cut, blanked, molded, or cast, or with any other suitable process. In at least one embodiment, the clamp is profile blanked and then machined using a computer numerical control (CNC) machine. The clamp may be manufactured from one or more materials, such as steel, aluminum, stainless steel, nickel-based alloys, nylon, or another suitable material. Note, however, the material of the clamp is generally selected to substantially match the strength of the material of the item being clamped (e.g., cylinder body of a gas spring).

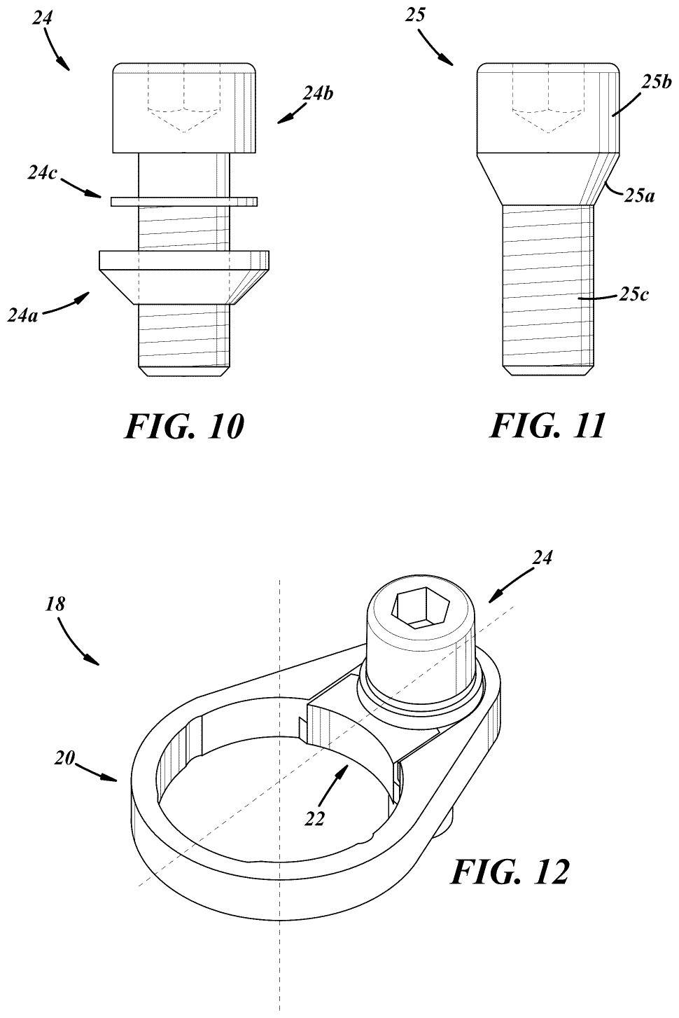

With continued reference to FIG. 3, the cam is shown engageable with the clamp to move the clamp transversely along the third passage toward the first portion of the mount ring. The cam can be a conical washer 24a and a fastener 24b, or a fastener 24b with a conical shoulder 25a, or any other component suitable for actuating a clamp (e.g., linearly or rotationally). For instance, in FIG. 10, the cam is shown including the conical washer 24a including a central aperture, a cylindrical portion, a cam upper surface, and a conical profile (e.g., tapered exterior) configured to engage with the surfaces of the mount ring countersink and the clamp countersink. The conical profile of the conical washer may include a diameter which is greater than the minimum distance between the mount ring countersink and the clamp countersink when the clamp is in the unclamped position (FIGS. 3 and 13).

The conical profile may form a variety of angles with the cylindrical portion for transferring force to and moving the clamp during assembly. Acute angles between the conical profile and the cylindrical portion may result in more clamping leverage and thus, better locking of the cam, but this arrangement typically requires greater overall travel for the cam. When angles between the conical profile and cylindrical portion are greater than 45 degrees, for example, the amount of force generated by the cam may be less but overall travel of the cam may be reduced. In the present illustrative embodiment, the angle between the conical profile and the cylindrical portion is 45 degrees and this angle provides about a 1:1 transmission of torque.

The cam further comprises the fastener 24b, such as a socket head fastener, which may include a head and a shank extending away from the head. External hexagon fasteners, lobe drive fasteners, or any other suitable fastener rated to supply sufficient clamp load may also be used. As shown in FIG. 10, the shank may extend through the central aperture so that the head may operatively engage the cam upper surface. In at least one embodiment, the cam may further include a spring washer 24c comprising a central aperture that is disposed between the conical washer and the head of the fastener so as to increase the surface area for the head of the fastener to fasten (i.e., clamp) on during assembly. The spring washer may be a compressible serrated washer, which may be desirable because fastener friction increases quickly during fastening and this may help prevent loosening.

The conical washer may be of any suitable construction and composition. For instance, the conical washer may be manufactured from one or more materials, such as steel, aluminum, stainless steel, nickel-based alloys, nylon, or another suitable material. Note, however, the material of the conical washer is generally selected so as to have a hardness between the hardness of the fastener and the hardness of the mount. In other words, in at least one embodiment, the conical washer will have a hardness between 15 Rc and 45 Rc on the Rockwell scale.

With reference to FIG. 11, another illustrative embodiment of a cam is shown comprising a fastener 25 having a head 25b including the conical shoulder 25a and a shank 25c extending from the head and configured to engage with the surfaces of the mount ring countersink and the clamp countersink. The conical shoulder may include a diameter that is greater than the minimum distance between the mount ring countersink and the clamp countersink when the clamp is in the unclamped position (FIGS. 3 and 13) so the cam can be fastened to transversely move the clamp.

With reference to FIG. 15, the clamp and the mount ring may be configured such that the contact between the conical profile of the cam and the clamp and the mount ring occurs at one area on the mount ring and one area on the clamp so that the clamp can move from the unclamped position to the clamped position. In the present illustrative embodiment, the cam is configured to contact an area on the clamp countersink and an area on the mount ring countersink during assembly. The clamp countersink and the mount ring countersink may also be configured (e.g., sized) to limit the amount of movement of the clamp along the third portion of the mount ring. For instance, the clamp countersink and the mount ring countersink may comprise a certain diameter compared to the minimum distance between the countersinks so that the clamp moves less than 1 mm when the cam is driven by the fastener to its clamping position. In any case, and as shown in FIG. 14, when the cam is driven to its clamping position by the fastener at its rated or full torque, the clamp is locked in a position along the transverse axis such that the clamp exhibits a proportional clamping load on a cylinder. In the present embodiment, the clamp assembly is configured such that clamping load is substantially equal at a contact point between the radially inwardly facing surface of the clamp and the cylinder and at least one additional contact point between the one or more clamping sections of the mount ring and the cylinder. The clamping load may help determine the axial holding load given a coefficient of friction (e.g., steel-steel: .15-.60) between the cylinder and the mount ring clamping surfaces, for example. Due to variation in surfaces or as a result of coatings or films from lubrication or other liquids associated with manufacturing that accumulate on clamping surfaces, it may be desirable to concentrate the clamping load through the mount ring reliefs to help compensate for any such variations.

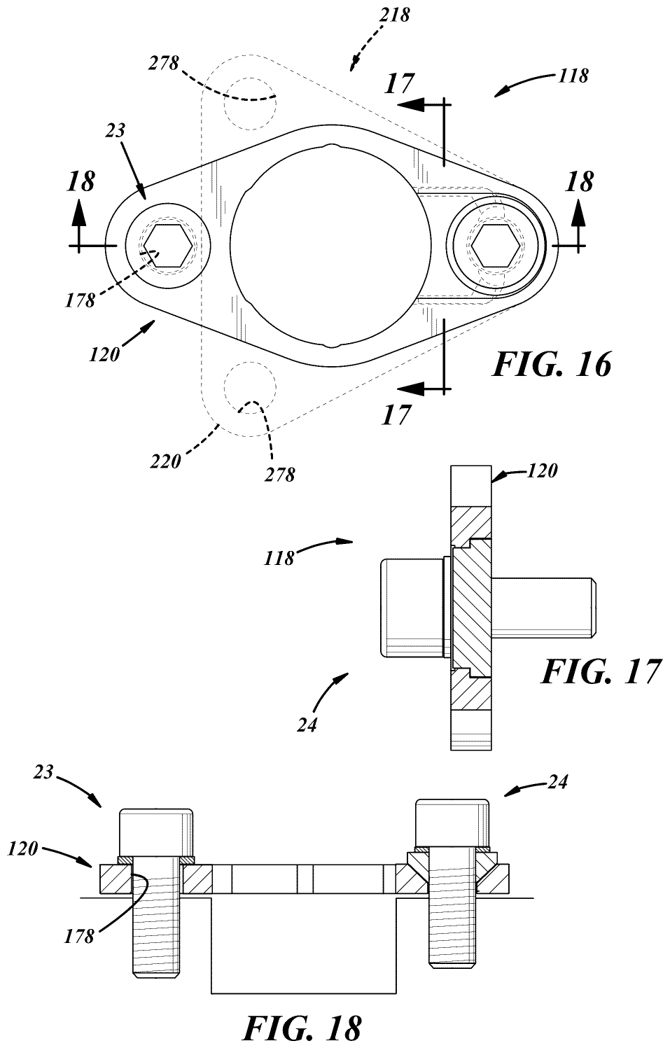

FIGS. 16-18 illustrate an additional illustrative embodiment of a clamp assembly 118 adapted for use with one or more additional fasteners. This embodiment is similar in many respects to the embodiment of FIGS. 1-15 and like numerals between embodiments generally designate like or corresponding elements. Accordingly, the descriptions of the embodiments are hereby incorporated into one another, and description of subject matter common to the embodiments may not be repeated.

In FIG. 16, a mount rings is illustrated and configured to accommodate one or more additional fasteners 23. For instance, mount ring′ 120 includes one additional through hole 78 and mount ring″ 220 (shown in dotted broken lines) includes two additional through holes 278. The additional through holes and fasteners may be desirable to provide additional support for the clamp assembly. During assembly, as introduced above, the clamp may be actuated and secured to a round body cylinder by fastening the cam to its rated or full torque. Subsequently, as shown in FIGS. 17 and 18, the additional fastener may be inserted through the through hole of mount ring′ 120 and fastened or otherwise clamped to its rated or full torque. The number of though holes and fasteners provided beyond that described in the first illustrative embodiment should not be construed or otherwise limited to the amount shown in the present illustrative embodiment, as this illustrative embodiment is just one example.

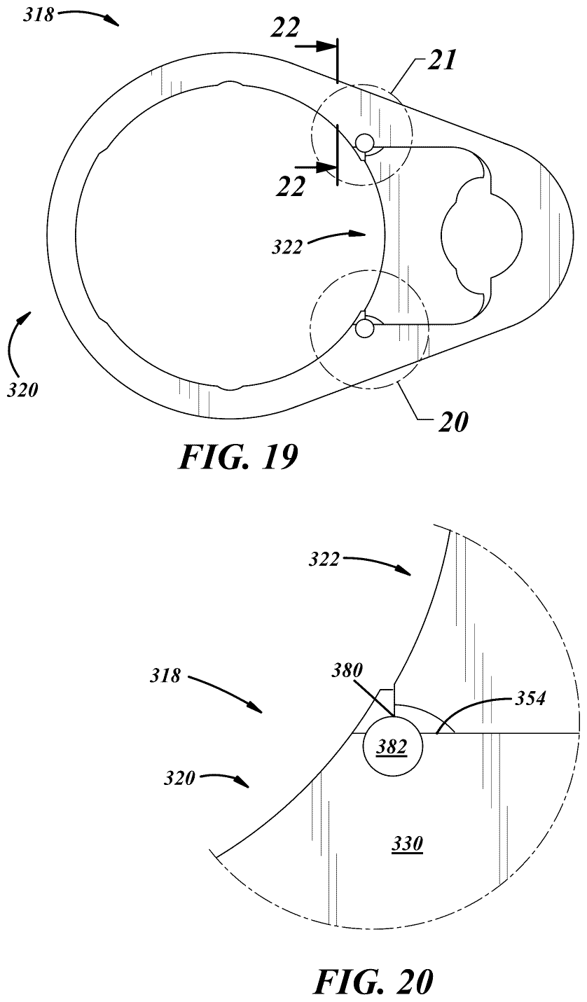

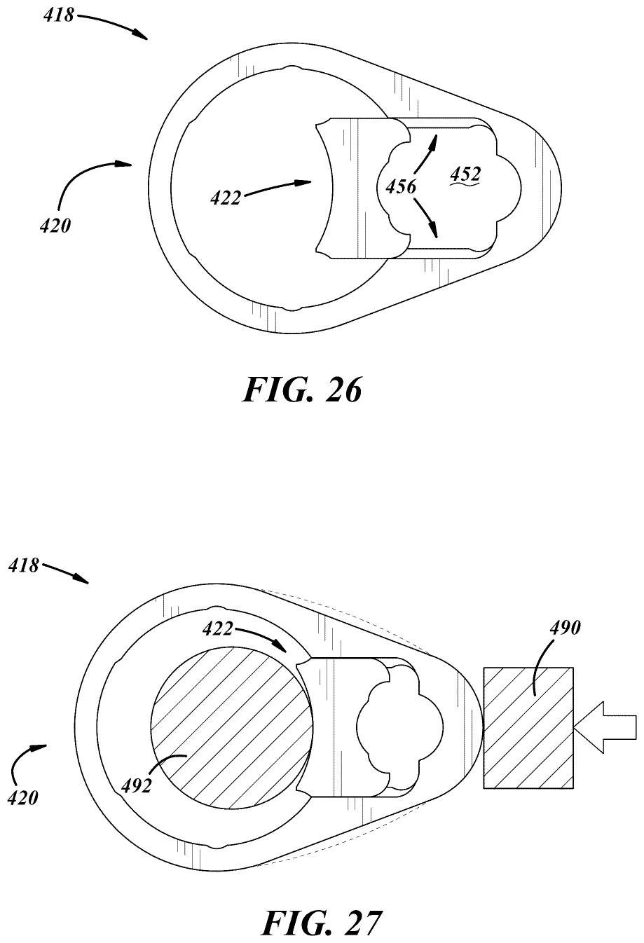

FIGS. 19-27 illustrate additional illustrative embodiments of a clamp assembly 318, 418 adapted for use with one or more additional fasteners. These embodiments are similar in many respects to the embodiments of FIGS. 1-18 and like numerals between embodiments generally designate like or corresponding elements. Accordingly, the descriptions of the embodiments are hereby incorporated into one another, and description of subject matter common to the embodiments may not be repeated.

From FIGS. 19-27, the present disclosure also provides a clamp assembly 318 with a retention function. The clamp assembly 318 includes a mount ring 320, a clamp 322 and a protrusion 380. The mount ring 320 includes an outer perimeter, a first passage, a second passage and a third passage. The first passage may be established by a first radially inwardly facing surface at a first radius from the first longitudinal axis extending through the first passage. The second passage may be established by a second radially inwardly facing surface at a second radius from the second longitudinal axis extending through the second passage and spaced transversely away from the first longitudinal axis. The third passage may be established by laterally inwardly facing walls extending along a transverse axis between the first longitudinal axis and the second longitudinal axis. The clamp 322 may be movable with respect to the mount ring 320 along a cam track of the third passable of the mount ring 320. The clamp assembly further includes a protrusion 380 that works in conjunction with the clamp 322 to enable retaining the clamp 322 within the third passage of the mount ring 320 and prevent free removal during assembly, packaging or transportation.

In FIGS. 19-20, a clamp 322 is retained in the clamp assembly 318 in an unclamped position. The protrusion 380, which intersects the third passage along the cam track, and engages laterally surface of the clamp 354 for contacting the clamp 322 in the third passage of the mount ring 320. The protrusion 380 is desirable for securing the clamp 322 and preventing its movement along the cam track in the third passage of the mount ring 320. When a cam is driven to its clamping position by engaging a fastener at its rated or full torque, the protrusion 380 allows the clamp 322 to move fully from the third passage of the mount ring 320 to a clamped position relatively toward a first portion of the mount ring. The protrusion 380 is desirable for retaining the clamp 322 in the unclamped position. Once the clamp 322 has fully moved from the third passage to the clamping position, the protrusion 380 prevents the clamp 322 from moving beyond the clamped position.

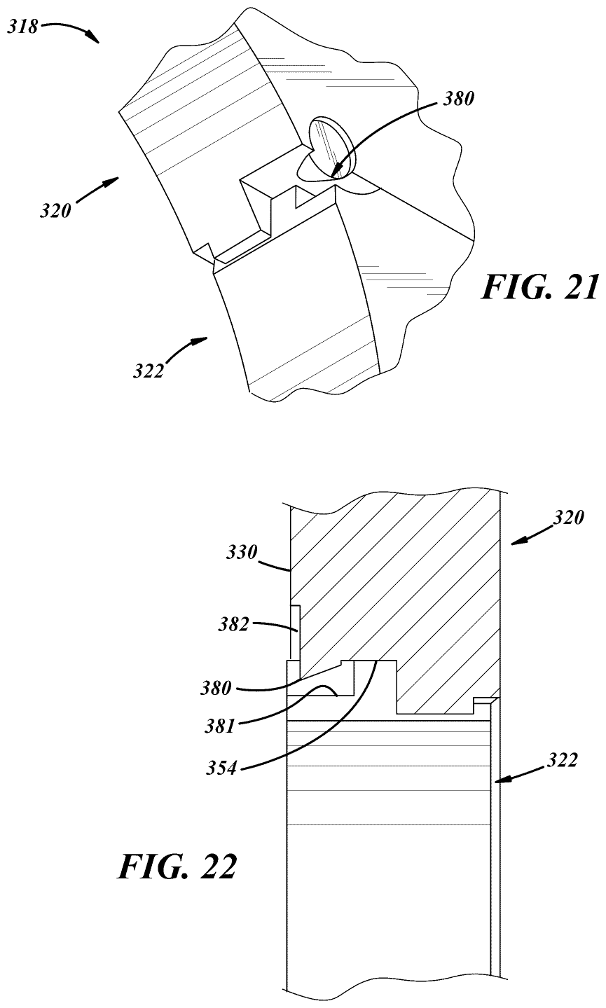

In FIG. 21, the protrusion 380 is formed after the cam is installed and may be formed by displacing small amount of material at the mount ring through processes such as dimpling, riveting or peening. In FIG. 22, the protrusion may be configured to engage with any laterally surface of the clamp for contacting the clamp in the third passage of the mount ring.

FIGS. 23-27 illustrate another illustrative embodiment of a clamp assembly 418 with a retention function. The clamp assembly 418 includes a mount ring 420, a clamp 422 and a protrusion 480 as same as the above embodiment, except the protrusion 480 which has a lead-in ramp 484 with a ramp angle of less than 10 degrees to retain the clamp 422 within the third passage. The protrusion 480 engages laterally surface of the clamp 454 for retaining the clamp in the third passage of the mount ring 420. In FIG. 23, a clamp 422 is retained in the clamp assembly 418 in an unclamped position. The protrusion 480, which intersects a third passage 452 along a cam track 456, is desirable for securing the clamp 422 and preventing its movement along the cam track 456 in the third passage 452 of the mount ring 420. A clamp side may be designed to match the ramp angle, enabling it to engage with a clamp groove. This configuration ensures the clamp 422 remains securely positioned within the third passage of the mount ring 420. When a cam is driven to its clamping position by engaging a fastener at its rated or full torque, the protrusion 480 allows the clamp 422 to move fully from the third passage 452 of the mount ring 420 to a clamped position relatively toward a first portion of the mount ring 420. As showed in FIG. 26, the clamp 422 is at a maximum extended position. The protrusion 480 is desirable for retaining the clamp 422 in the unclamped position. Once the clamp 422 has fully moved from the third passage 452 to the clamping position, the protrusion 480 prevents the clamp 422 from moving beyond the clamped position.

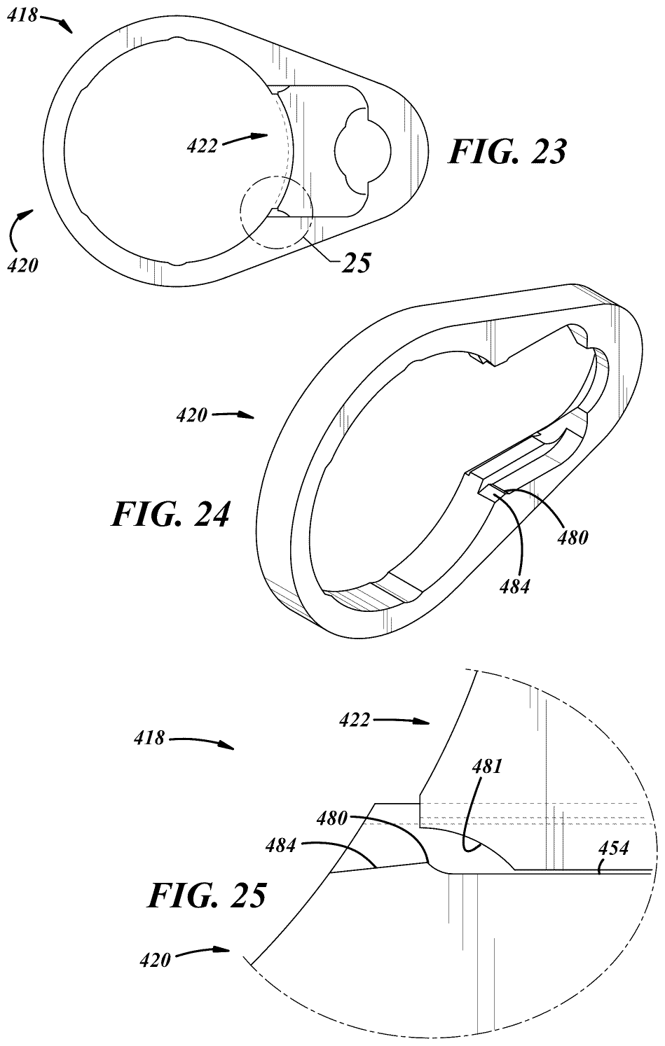

The protrusion 480 is pre-formed before assembly of the clamp to the mount ring 420. In FIG. 27, the section of mount ring 420 responding to the third passage is thin. Thus, forcing the slide 490 with fixed backing 492 into the ring will cause the outer mount ring to flex within its elastic yield limits, which may spring open to allow assembling the clamp 422, followed by snapping back into a free fit slide area. The mount ring 420 is compressible along the transverse axis to widen the third passage and the cam track, allowing the insertion of the clamp 422 past the protrusion 480 and into the third passage. In FIG. 24, the protrusion 480 may be configured to engage with any laterally surface of the clamp for contacting the clamp in the third passage of the mount ring.

As used in herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. As used herein, permissive terms like “may” and “can” are expedients merely to indicate optionality, for instance, of a disclosed embodiment, element, feature, or the like, and should not be construed as rendering indefinite any disclosure herein. Moreover, directional words such as front, rear, top, bottom, upper, lower, radial, circumferential, axial, lateral, longitudinal, vertical, horizontal, transverse, and/or the like are employed by way of example and not necessarily limitation.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A clamp assembly, comprising:
a mount ring including:
an ovate outer perimeter,
a top surface,
a bottom surface, and
a first portion including a first passage established by a first radially inwardly facing surface at a first radius from a first longitudinal axis extending through the first passage,
a second portion including
a second passage established by a second radially inwardly facing surface at a second radius from a second longitudinal axis extending through the second passage and spaced transversely away from the first longitudinal axis of the first portion, and
a mount ring countersink in the top surface and coaxial with the second passage, and
a third portion including a third passage established by laterally inwardly facing walls and extending along a transverse axis between the first longitudinal axis and the second longitudinal axis;
a clamp movably carried in the third passage of the third portion of the mount ring, movable along the transverse axis between an unclamped position relatively toward the second portion and a clamped position relatively toward the first portion, and including a radially inwardly facing clamp surface corresponding to the first radially inwardly facing surface and a cam countersink corresponding to the mount ring countersink; and
a cam engageable with the clamp to move the clamp along the third passage toward the first portion of the mount ring.

2. The clamp assembly of claim 1, wherein the cam includes a conical washer including a central aperture, a conical profile having a diameter that is greater than a distance between the mount ring countersink and the cam countersink when the clamp is in the unclamped position, and a cam upper surface, and a fastener including a head to operatively engage the cam upper surface and a shank extending away from the head and through the central aperture of the cam.

3. The clamp assembly of claim 2, wherein the clamp and the mount ring are configured such that contact between the conical profile of the cam and the clamp and the mount ring occurs at one area on the mount ring and one area on the clamp so that the clamp can move from the unclamped position to the clamped position.

4. The clamp assembly of claim 1 wherein the first portion is elastically deformable and includes at least one first portion relief and at least one clamping section spaced circumferential from the at least one first portion relief, and wherein the at least one clamping section and the clamp are configured to exert substantially uniform tension around a cylinder when the clamp is in the clamped position.

5. The clamp assembly of claim 1 wherein the second portion includes at least one second portion relief spaced circumferentially on either side of the second radially inwardly facing surface.

6. A clamp assembly, comprising:
a mount ring including
an outer perimeter,
a first passage extending along a first longitudinal axis,
a second passage extending along a second longitudinal axis spaced transversely apart from the first passage, and
a third passage extending along a transverse axis between the first and second longitudinal axes;
a clamp configured to be movable with respect to the mount ring along the third passage of the mount ring; and
a cam configured to engage with and actuate the clamp along the third passage.

7. The clamp assembly of claim 6, wherein the outer perimeter of the mount ring is ovate and circumferentially continuous.

8. The clamp assembly of claim 6, wherein the first passage includes a first passage radius and the second passage includes a second passage radius, the first passage radius being greater than the second passage radius.

9. The clamp assembly of claim 6, wherein the third passage includes a clamp track that is parallel to the transverse axis and includes two laterally facing surfaces which support and guide the clamp along the transverse axis.

10. The clamp assembly of claim 6, wherein the cam includes a conical washer having a central passage and a fastener including a shank extending through the central passage and a head to operatively engage the cam.

11. The clamp assembly of claim 10, wherein the cam includes a conical profile such that contact between the conical profile and the mount ring and the clamp moves the clamp along the transverse axis.

12. A clamp assembly, comprising:
a mount ring including:
an ovate outer perimeter,
a top surface,
a bottom surface,
a first portion including a first passage established by a first radially inwardly facing surface at a first radius from a first longitudinal axis extending through the first passage, and having one or more first portion reliefs in the first radially inwardly facing surface and spaced circumferentially around the first radially inwardly facing surface,
a second portion including a second passage established by a second radially inwardly facing surface at a second radius from a second longitudinal axis extending through the second passage and spaced transversely away from the first longitudinal axis of the first portion, and having a mount ring countersink in the top surface and coaxial with the second passage, and also having one or more second portion reliefs spaced circumferentially on either side of the mount ring countersink, and
a third portion including a third passage established by laterally inwardly facing walls and extending along a transverse axis between the first longitudinal axis and the second longitudinal axis and including a clamp track established by laterally inwardly facing walls, and including protrusions extending laterally inwardly from the laterally inwardly facing walls;
a clamp carried by the clamp track of the third portion of the mount ring, movable along the transverse axis between an unclamped position relatively toward the second portion and a clamped position relatively toward the first portion, and including a radially inwardly facing clamp surface corresponding to the first radially inwardly facing surface and a cam countersink corresponding to the mount ring countersink;
a cam to actuate the clamp, and including
a conical washer including a central aperture, a conical profile including a diameter that is greater than a distance between the mount ring countersink and the cam countersink when the clamp is in the unclamped position, and an upper surface; and
a socket head cap fastener including a head to operatively engage the upper surface of the conical washer, and a shank extending away from the head and through the central aperture of the conical washer.

13. A mount ring, comprising:
an ovate outer perimeter;
a top surface;
a bottom surface;
a circular portion including a first passage established by a first radially inwardly facing surface at a first radius from a first longitudinal axis extending through the first passage;
an arcuate portion including a second passage established by a second radially inwardly facing surface at a second radius from a second longitudinal axis extending through the second passage and also including a mount ring countersink in the top surface and coaxial with the second passage; and
a straight portion including a third passage established by laterally inwardly facing walls extending along a transverse axis between the first longitudinal axis and the second longitudinal axis.

14. The mount ring of claim 13, wherein the ovate outer perimeter is circumferentially continuous.

15. The mount ring of claim 13, wherein the circular portion includes relief sections and contact sections circumferentially spaced about the first radially inwardly facing surface.

16. The mount ring of claim 13, wherein the arcuate portion includes at least one relief section spaced circumferential on either side of the second passage.

17. The mount ring of claim 13, wherein the first radius is greater than the second radius.

18. A clamp, comprising:
a radially inner end at a first radius from a first longitudinal axis;
a radially outer end at a second radius from a second longitudinal axis;
an upper surface;
a lower surface;
a first laterally outer side extending between the upper and lower surfaces and having a first track element;
a second laterally outer side extending between the upper and lower surfaces and having a second track element; and
a countersink in the upper surface and extending between the upper surface and the radially outer end.

19. The clamp of claim 18, wherein the first and second track elements of the first and second laterally outer sides include grooves/slots.

20. The clamp of claim 18, further including one or more reliefs spaced circumferentially on either side of the radially outer end.

21. A clamp assembly, comprising:
a mount ring including
an outer perimeter,
a first passage extending along a first longitudinal axis,
a second passage extending along a second longitudinal axis spaced transversely apart from the first longitudinal passage, and
a third passage extending along a transverse axis between the first and second longitudinal axes;
a clamp movable with respect to the mount ring along a cam track of the third passage of the mount ring; and
a protrusion intersecting the third passage along the cam track to retain the clamp in the third passage of the mount ring.

22. The clamp assembly of claim 21, wherein the protrusion is formed after the clamp is installed.

23. The clamp assembly of claim 22, wherein the protrusion is formed by displacing material of the mount ring by dimpling, riveting or peening.

24. The clamp assembly of claim 22, wherein the protrusion engages a lateral surface of the clamp contacting the third passage of the mount ring.

25. The clamp assembly of claim 22, wherein the protrusion prevents the clamp from moving beyond a clamped position.

26. The clamp assembly of claim 21, wherein the protrusion has a lead-in ramp with a shallow angle of less than 10 degrees.

27. The clamp assembly of claim 26, wherein the protrusion is pre-formed before assembly of the clamp to the mount ring, and the mount ring is compressible along the transverse axis to cause the third passage and the cam track to widen to allow insertion of the clamp past the protrusion and into the third passage.

28. The clamp assembly of claim 26, wherein the lead-in ramp is positioned on a lateral surface of the third passage of the mount ring to engage the clamp.
